(19) United States
(12) Patent Application Publication
(10) Pub. No.: US 2020/0081930 A1
(43) Pub. Date: Mar. 12, 2020

(54) ENTITY-BASED SEARCH SYSTEM USING USER ENGAGEMENT

(71) Applicant: Branch Metrics, Inc., Redwood City, CA (US)

(72) Inventors: Zeesha Currimbhoy, Sunnyvale, CA (US); Alexander Austin, Palo Alto, CA (US); Eric J. Glover, Palo Alto, CA (US); Jyotsna Jayaraman, San Francisco, CA (US); Jonas Frederick Bauer, Atherton, CA (US); Kan Yu, San Mateo, CA (US); Charles Currin Gilliam, Raleigh, NC (US); Rishi Khaitan, San Francisco, CA (US)

(73) Assignee: Branch Metrics, Inc., Redwood City, CA (US)

(21) Appl. No.: 16/561,848

(22) Filed: Sep. 5, 2019

Related U.S. Application Data
(60) Provisional application No. 62/802,256, filed on Feb. 7, 2019.
(60) Provisional application No. 62/769,096, filed on Nov. 19, 2018.
(60) Provisional application No. 62/731,177, filed on Sep. 14, 2018.
(60) Provisional application No. 62/727,725, filed on Sep. 6, 2018.

(51) Int. Cl. G06F 16/9536; G06F 16/9538

(52) U.S. Cl. CPC G06F 16/9536; G06F 16/9538

(57) ABSTRACT

A method includes storing entity records that include entity information that describes an entity and an application link that accesses an application state associated with the entity. The method includes receiving event data from user devices that indicates a number of times each of the application states was accessed by the user devices. The method includes determining a popularity score for each entity record based on the received event data, wherein the popularity score indicates the number of times the application state for the entity record was accessed relative to the number of times other application states were accessed. The method includes identifying a set of preliminary result entity records based on a search request, generating result scores for each of the preliminary result entity records based on the popularity scores, and generating search results that include application links from the preliminary result entity records.

### CROSS-REFERENCE TO RELATED APPLICATIONS

This application claims the benefit of U.S. Provisional Application No. 62/727,725, filed on Sep. 6, 2018, U.S. Provisional Application No. 62/731,177, filed on Sep. 14, 2018, U.S. Provisional Application No. 62/769,096, filed on Nov. 19, 2018 and U.S. Provisional Application No. 62/802,256, filed on Feb. 7, 2019. The disclosures of the above applications are incorporated herein by reference in their entirety.

### FIELD

The present disclosure relates to providing search results for applications.

### BACKGROUND

Software developers develop a wide range of applications that are accessed by users on a variety of different platforms, such as different computing devices and operating systems. Example applications may include e-commerce applications, media streaming applications, business review applications, social media applications, and news applications. These applications can provide users with different functionalities for a variety of different entities, such as consumer product entities and digital media entities (e.g., movies/songs). For example, an e-commerce application can provide consumer products for sale to users. As another example, a media streaming application can play movies or songs for a user.

### SUMMARY

In one example, a method comprises storing, at a server, a plurality of entity records. Each entity record includes entity information that describes an entity and an application link configured to access an application state associated with the entity. The method comprises receiving event data generated by a plurality of user devices. The event data indicates a number of times each of the application states was accessed by the user devices. The method further comprises determining a popularity score for each entity record based on the received event data. The popularity score indicates the number of times the application state for the entity record was accessed relative to the number of times one or more other application states were accessed. The method further comprises receiving a search request from a remote requesting device and identifying a set of preliminary result entity records based on matches between the search request and the entity information included in the preliminary result entity records. The method further comprises generating result scores for each of the preliminary result entity records based on the popularity scores associated with the preliminary result entity records and generating search results that include application links from the preliminary result entity records. The application links in the search results are ranked according to the result scores associated with the application links. Additionally, the method comprises sending the search results from the server to the requesting device.

A system comprises one or more storage devices and one or more processing units. The one or more storage devices are configured to store a plurality of entity records. Each entity record includes entity information that describes an entity and an application link configured to access an application state associated with the entity. The one or more processing units are configured to execute computer-readable instructions that cause the one or more processing units to receive event data generated by a plurality of user devices. The event data indicates a number of times each of the application states was accessed by the user devices. The one or more processing units are configured to determine a popularity score for each entity record based on the received event data. The popularity score indicates the number of times the application state for the entity record was accessed relative to the number of times one or more other application states were accessed. The one or more processing units are configured to receive a search request from a remote requesting device, identify a set of preliminary result entity records based on matches between the search request and the entity information included in the preliminary result entity records, and generate result scores for each of the preliminary result entity records based on the popularity scores associated with the preliminary result entity records. The one or more processing units are configured to generate search results that include application links from the preliminary result entity records. The application links in the search results are ranked according to the result scores associated with the application links. Additionally, the one or more processing units are configured to send the search results to the requesting device.

### BRIEF DESCRIPTION OF THE DRAWINGS

The present disclosure will become more fully understood from the detailed description and the accompanying drawings.

FIG. 1 illustrates an environment that includes a search system and an event system of the present disclosure.

FIG. 2 is an example method that describes operation of the search system and the event system.

FIG. 3A is a functional block diagram of an event system.

FIG. 3B illustrates an example user data object.

FIG. 4 is a functional block diagram of an example search system.

FIG. 5A illustrates an example application-specific entity record.

FIG. 5B illustrates an example merged entity record.

FIG. 6A is an example method for calculating popularity scores based on event data.

FIG. 6B is an example method for calculating popularity scores based on application-specific data.

FIG. 7A is a functional block diagram of another example search system.

FIG. 7B is an example method that describes operation of the search system of FIG. 7A.

FIG. 8A illustrates an example search result page in which the search results are ranked by result score.

FIG. 8B illustrates an example search result page in which the search results are organized by application.

FIG. 8C illustrates an example search result page in which the search results are organized by vertical.

FIG. 9 is a functional block diagram of another example search system.

FIG. 10 is an example method that describes operation of the search system of FIG. 9.

In the drawings, reference numbers may be reused to identify similar and/or identical elements.

### DETAILED DESCRIPTION

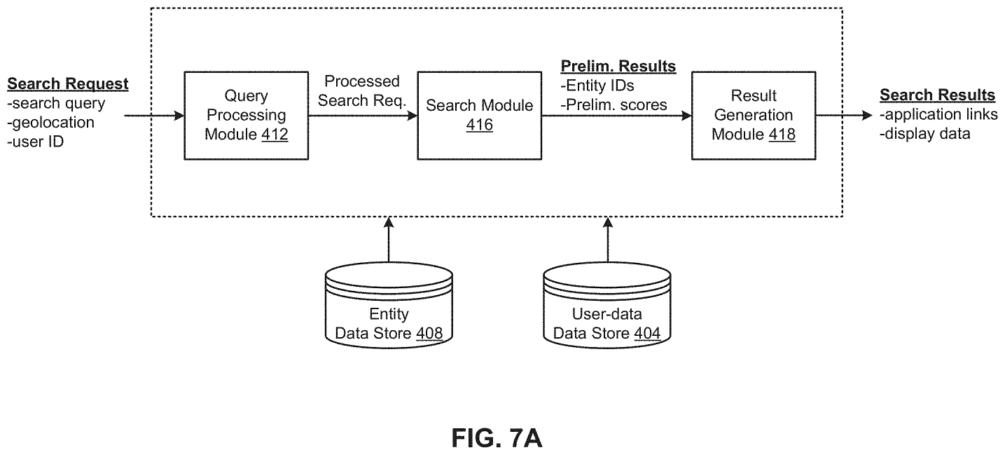

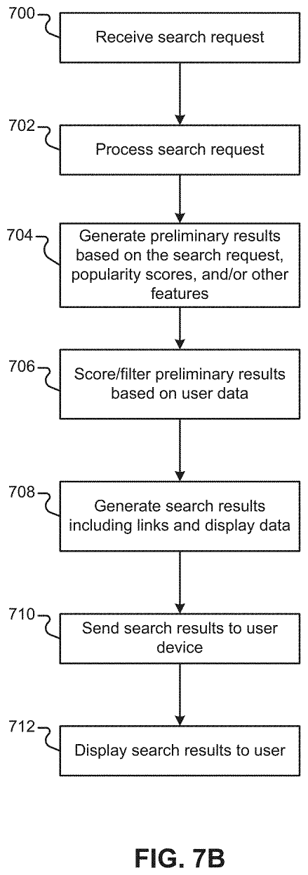

A search system of the present disclosure receives a search request from a user device, generates search results, and sends the search results to the user device (e.g., see FIG. 7A). The search results may include user-selectable links that access content for entities in applications and websites. For example, the user-selectable links may access content (e.g., pages) for business entities, movie entities, music entities, and other types of entities.

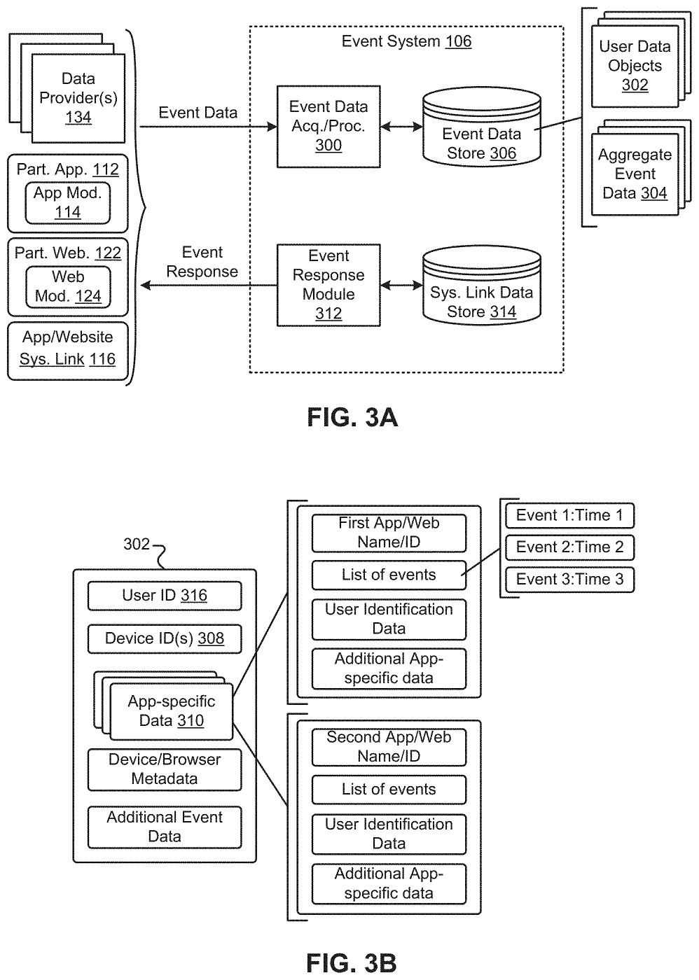

An event system of the present disclosure acquires event data that indicates how users engage with applications and websites (e.g., see FIG. 3A). For example, the event system may receive event data from application/web modules that report the event data from user devices. Application event data may include application events, such as opening an application, accessing a state of an application (e.g., a page), and making a purchase in the application. Web event data may include web events, such as accessing web pages and purchasing items on websites.

The search system may generate search results based on event data that has been aggregated for a plurality of users. Event data that has been aggregated may be referred to herein as “aggregate event data/values.” Example aggregate event data may include an active user count, such as daily/monthly active user counts. The search system may also generate personalized search results for the user device based on event data associated with the user device (referred to herein as “user-specific event data” or “user data”). Example user-specific event data may include installation data that indicates whether specific applications are installed on the user device. User-specific event data may also indicate how frequently the user has engaged with specific applications/websites.

In some implementations, the search system may generate personalized search results for a user device based on the user's engagement with applications and websites while using other user devices. In these implementations, the search system may generate search results based on user-specific event data for the same user across multiple devices. The user-specific events may be connected to one another (e.g., by user identification data).

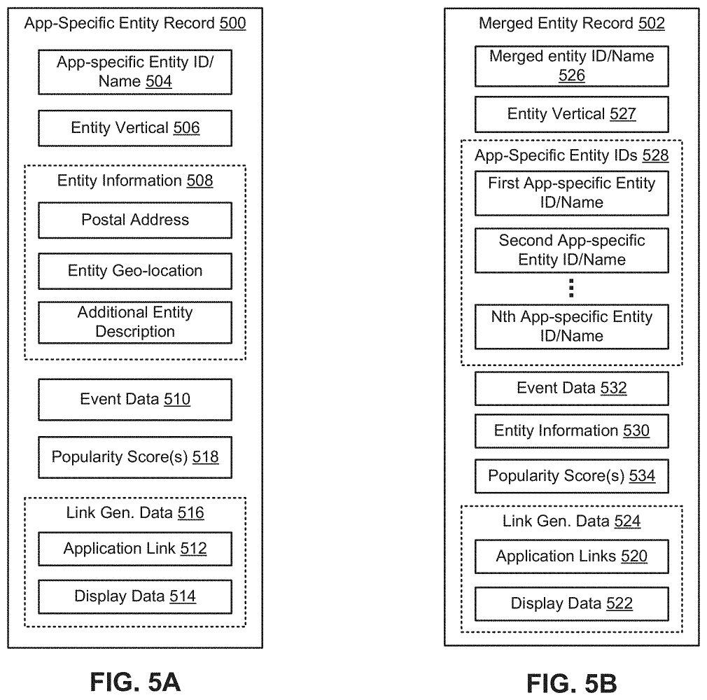

The search system may store entity records (e.g., see FIGS. 5A-5B) that the search system uses for search. The entity records may include data related to entities, such as an entity name and an entity description. Example entities may include persons, places, or things, such as specific restaurants, movies, cities, actors, etc. The entity records may also include links to the entities in applications/websites, such as Uniform Resource Locator (URL) links.

The entity records may include application-specific entity records and/or merged entity records. Application specific entity records (“app-specific entity records”) may include data related to an entity in a specific application, along with a link (e.g., URL) to the entity within the specific application. For example, an app-specific entity record for a restaurant in an application may include data associated with the restaurant, along with a link to the restaurant in the application. A merged entity record may include data for an entity across multiple applications, along with links to the entity in the multiple applications.

In some implementations, the search system may determine popularity scores for entities based on aggregate event data associated with the entities. A popularity score may indicate the popularity of the entity relative to other entities. The search system may determine a popularity score for an entity based on a number of engagements with the entity relative to a number of engagements with other entities. The search system may score/filter the search results based on the popularity scores associated with the entities. The personalization, aggregate event data, and popularity scores used by the search system can help assure that search results provide popular entities that are relevant to the user.

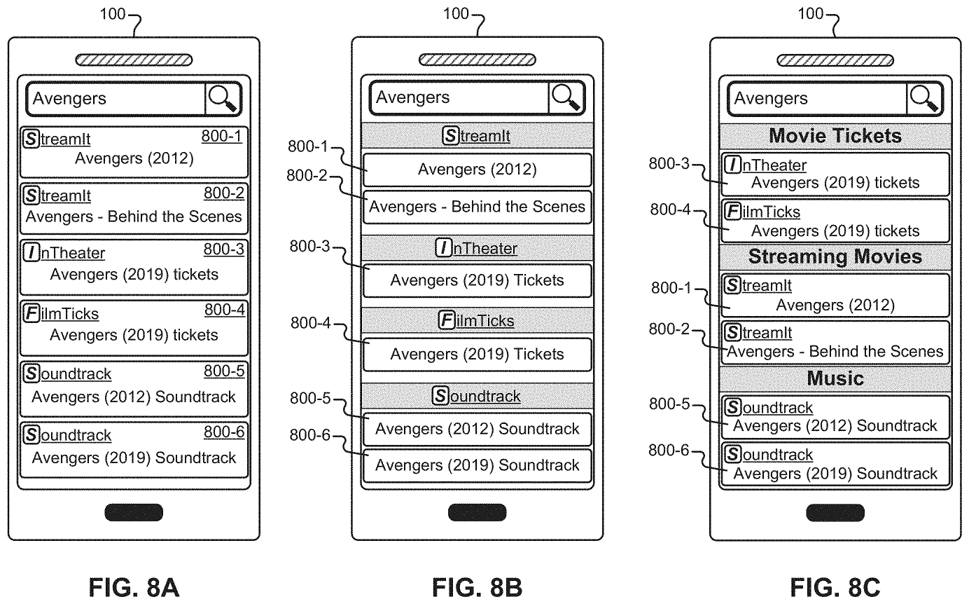

In some implementations, the search system may group search results for ranking and/or display. For example, the search system may group search results together by the application associated with the search results (e.g., see FIG. 8B). In this example, the search system may rank the application result groups based on the user's previous engagements with applications and/or aggregate engagement with the application.

In some implementations, the search system may group search results together by the vertical (e.g., category) associated with the search results (e.g., see FIG. 8C). For example, the search system may group the search results by business type (e.g., restaurant, hotel, etc.). As another example, the search system may group the search results by media type (e.g., video, audio). In some implementations, the search system may determine a user's vertical intent (e.g., categorical preference) for search results based on the search query and/or other data. The search system may rank the vertical result groups based on the determined vertical intent. Ranking by application and/or a user's vertical intent may help assure that the user is presented with search results that are relevant and personalized to the user's application preferences as indicated by their user history and submitted search query.

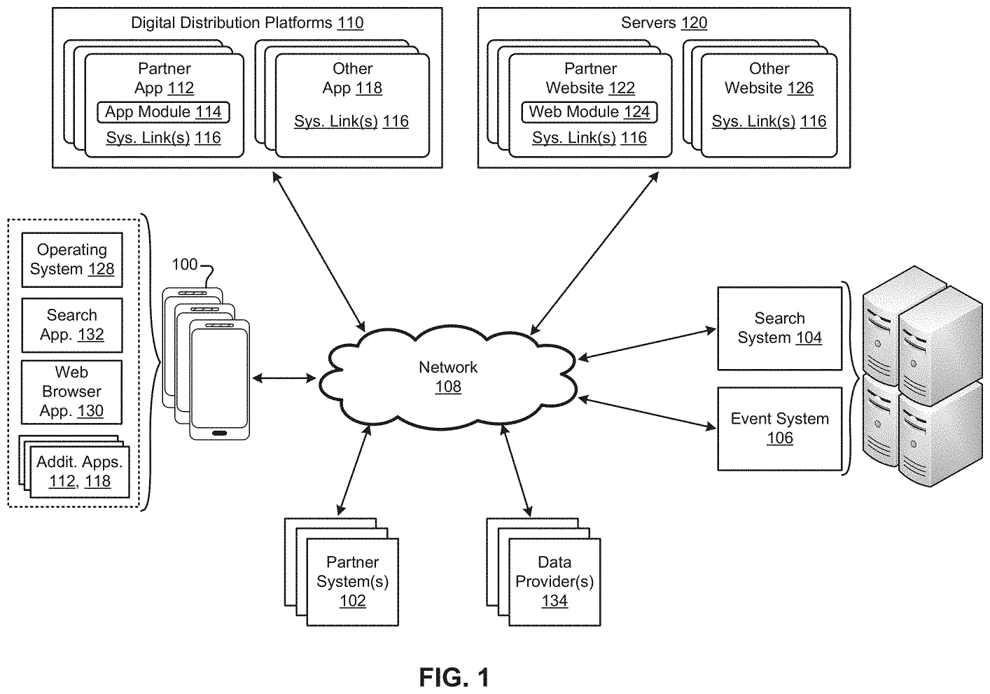

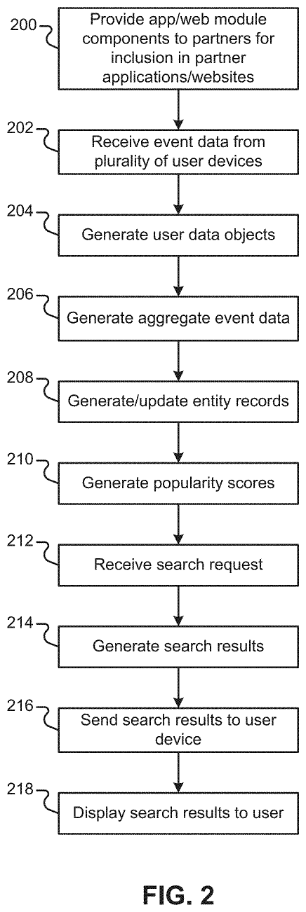

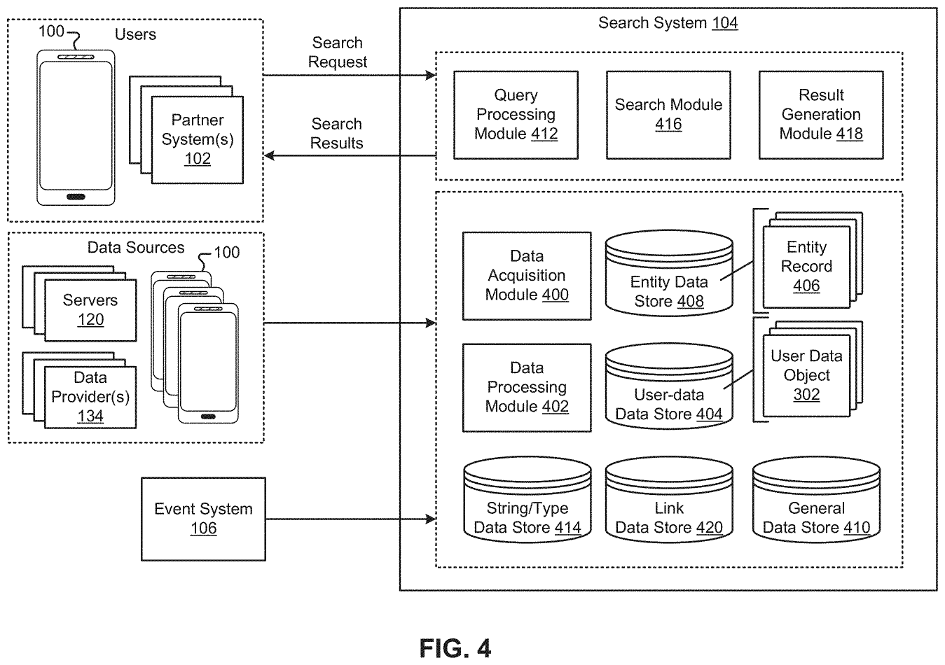

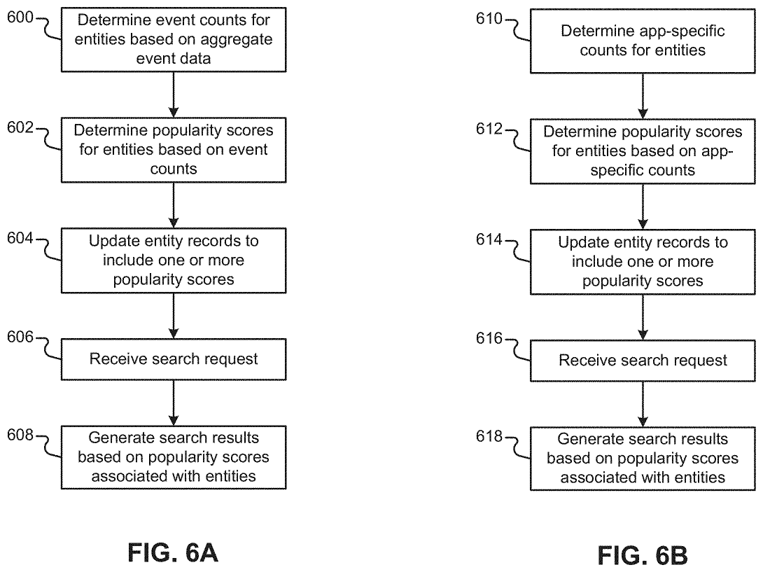

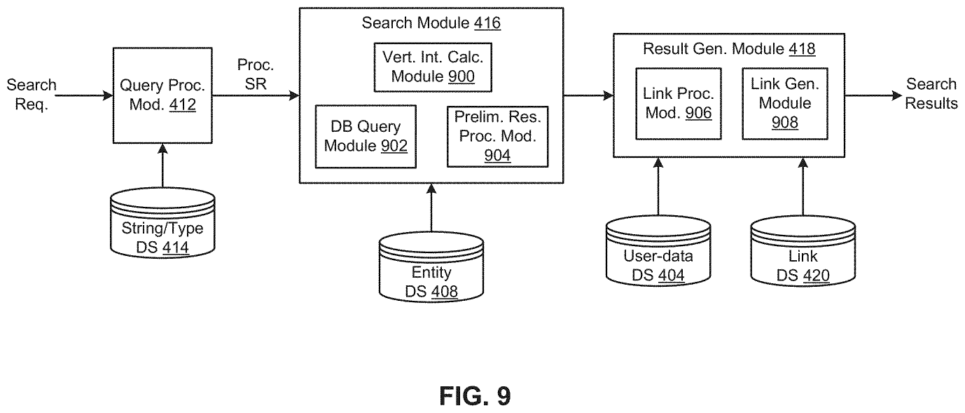

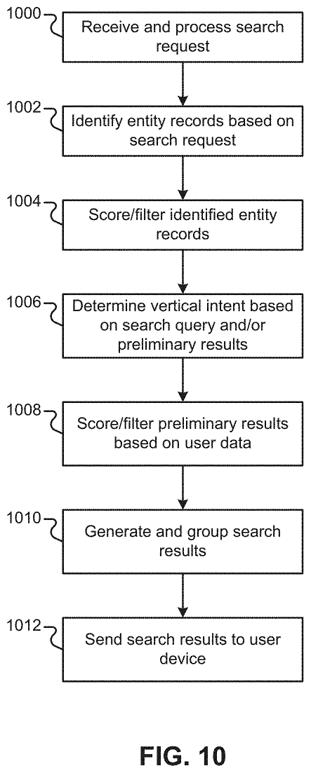

FIGS. 1-10 illustrate operation of an example search system and event system of the present disclosure. FIGS. 1-2 illustrate operation of an environment that includes the search system and the event system. FIGS. 3A-3B illustrate operation of an example event system. FIG. 4 illustrates an example search system. FIGS. 5A-5B illustrate example entity records. FIGS. 6A-6B illustrate example methods for calculating popularity scores. FIGS. 7A-7B illustrate operation of an example search system. FIGS. 8A-8C illustrate example groupings of search results. FIGS. 9-10 illustrate operation of another example implementation of the search system.

FIG. 1 illustrates an environment that includes a plurality of user devices 100, a plurality of partner systems 102, a search system 104 (e.g., a server computing device), and an event system 106 (e.g., a server computing device) in communication via a network 108. The network 108 may include various types of computer networks, such as a local area network (LAN), wide area network (WAN), and/or the Internet. The search system 104 may receive search requests including search queries from the user devices 100 and partner systems 102 (e.g., partners of the search system 104 and/or event system 106). The search system 104 processes the search queries, performs one or more searches, and outputs search results that include links to application states and/or websites. The application states (e.g., for installed applications) and/or websites may be associated with entities and actions that resolve the user's search query.

The environment includes one or more digital distribution platforms 110. The digital distribution platforms 110 may represent computing systems that are configured to distribute applications to user devices 100. Example digital distribution platforms include, but are not limited to, the GOOGLE PLAY® digital distribution platform by Google, Inc. and the APP STORE® digital distribution platform by Apple, Inc. The digital distribution platforms 110 may include one or more partner applications 112 (e.g., partners of the search system 104 and/or event system 106), each of which may include an app module 114 and/or system links 116 (e.g., links to event system content). The digital distribution platforms 110 may also include a plurality of applications 118 developed by parties other than the partners. Users may download the applications from the digital distribution platforms 110 and install the applications on user devices 100.

The environment includes a plurality of servers 120 (e.g., web servers). The servers 120 may serve websites (or web applications) to the user devices 100. In some implementations, the servers 120 may serve partner websites 122 to the user devices 100. A partner website 122 may include a web module 124, as configured by the partner, along with one or more system links 116. The servers 120 may also serve other websites 126 (e.g., other than those operated by the partners). In some cases, the other websites 126 may include system links 116.

The user device 100 includes an operating system 128 and a plurality of applications, such as a web browser application 130 and additional applications 112, 118. Example additional applications may include, but are not limited to, e-commerce applications, social media applications, business review applications, banking applications, gaming applications, and weather forecast applications. Using the web browser 130, the user device 100 can access various websites on the servers 120 via the network 108. The user device 100 may also download applications from the digital distribution platforms 110 via the network 108 and install the applications.

The partner applications 112, partner websites 122, and partner systems 102 can be partners of the search system and/or event system owner/operator. Various types of partners may operate the partner systems 102 and develop the partner applications 112 and the partner websites 122. The developers of the partner applications 112 and websites 122 may be different parties than those that own/operate the partner systems 102. Partners (e.g., partner systems 102) may access the search system using an application programming interface (API). In some implementations, partners may provide partner applications 112 (e.g., standalone applications, launcher applications, or other applications) that communicate directly with search system 104 and/or via the partner systems 102 (e.g., via an API).

The user device 100 includes a search application 132. The search application 132 can communicate with the search system 104 and/or the partner systems 102 to receive search results. For example, the search application 132 can receive a user's search query and make a search request to the search system 104 and/or the partner systems 102. The search application 132 can receive and display search results received from the search system 104 and/or partner systems 102.

Search results received by the search application 132 can include display data for rendering the search results in a graphical user interface (GUI). The display data may include, but is not limited to: 1) the application name, 2) the title of the result (e.g., a restaurant name), 3) a description of the state associated with the result (e.g., a description of a restaurant), 4) one or more images associated with the application state, and 5) one or more actions associated with the result. The search results can also include data for accessing the application states associated with the search results. An application state may generally refer to a page/screen of an application. In some cases, the search results can include application URLs that launch the application states on the user device 100. In other cases, the search results can include application metadata that the application can use to access the application state.

The user can select one of the search results in the GUI. The user device 100 can open the application state associated with the search result using the data included in the received search result. The user may then interact with the accessed application state. In a specific example, with respect to the YELP® business directory application developed by Yelp, Inc., selecting a YELP® application search result for the Round Table Pizza restaurant may access the Round Table Pizza application state of the YELP® application.

A user device 100 downloads and installs the partner applications 112 from a digital distribution platform 110. The search application 132 may be implemented on the user device 100 in a variety of ways. In some implementations, the user may download the search application 132 (e.g., from a digital distribution platform 110) and install the search application 132 on the user device 100. In other implementations, the search application 132 may be installed on the user device 100 before the user purchases the user device 100 (e.g., as a preloaded application). In some cases, the search application 132 may be referred to as a “native application” or a “widget.” In some implementations, the functionality attributed to the search application 132 herein may be included in other applications, such as a launcher application or as part of a smart assistant device, such as a smart speaker device (e.g., an ECHO smart speaker by Amazon.com, Inc., a GOOGLE HOME smart speaker by Google, Inc., or an Apple HOMEPOD smart speaker by Apple, Inc.). In some implementations, the search application 132 can communicate with the search system 104 via the partner systems 102. In some implementations, the functionality attributed to the search application 132 herein may be implemented as a web-based search accessed using the web browser 130 on the user device 100.

The user can enter a search query into the search application 132 (e.g., see FIGS. 8A-8C). The search application 132 generates a search request including the search query and other data. In some implementations, the search application 132 can acquire context data to include in the search request. Context data may include a variety of types of data, such as a user ID, operating system information, device type information, geolocation data, time of day, query history data (e.g., one or more prior queries in the search application), application usage data, user state of motion data (e.g., walking, biking, driving), user-historical context (e.g., all of the above historically), and/or category of the query (e.g., selected in the GUI).

In some implementations, the search application 132 can include user-specific data in the search request, such as user preferences and/or user historical data associated with the search application. Example user-specific data may include, but is not limited to, user demographic data, user geo-location preferences, past queries, and vertical/categorical preferences, such as cuisine preferences or hotel preferences. The search application 132 may store the user-specific data associated with the search application.

An event system 106 of the present disclosure receives event data generated by user devices 100 (e.g., mobile computing devices). User devices 100 may generate event data while a user is browsing websites and/or using an application (e.g., a native application) installed on the user device 100. For example, event data may be generated when a user opens/closes an application, views a webpage, and/or selects links (e.g., hyperlinks) in an application or on a webpage.

The event system 106 can track events that occur on user devices 100 over time and attribute the occurrence of some events to prior events. For example, the event system 106 may attribute the installation of an application to a prior user selection of a link, such as a hyperlink on a webpage or a banner advertisement. As another example, the event system 106 may attribute the purchase of an item on a website and/or application to a previously selected link. The attribution functionality provided by the event system 106 can be useful to a variety of parties, such as businesses, advertisers, and application developers that may wish to monitor performance of their applications/websites. Additionally, the attribution functionality provided by the event system 106 may also be used to provide various functionality to user devices 100, such as routing a user device into an application state in response to user selection of a web link.

The event system 106 can generate aggregate event data based on the event data for a plurality of users. Aggregate event data can include aggregate data indicating engagement with applications, such as an active user count. Aggregate event data may also indicate a number of events for entities over a time period. In some implementations, the aggregate events may be categorized according to event type. The aggregate event data may be calculated for different geolocations, languages, device types, and other parameters.

A partner can integrate with the event system 106 in a variety of ways. For example, the partner can retrieve application and web module components that the partner can modify and include into their application(s) and website. The application module components may include software libraries and functions/methods that may be included in the partner's application 112. The functions/methods may be invoked by the application to request system links 116, handle the selection of system links 116, transmit event data to the event system 106 (e.g., application open events), and handle data received from the event system 106. The web module components may include software libraries and functions/methods that may be included in the partner's website 122. The functions/methods (e.g., JavaScript) may be invoked to provide the website with various functionalities described herein with respect to the event system 106. For example, the functions/methods may be invoked to request system links 116, handle the selection of system links 116, transmit event data to the event system 106 (e.g., webpage view events), and handle data received from the event system 106. The application and web module components can include computer code that provides features for communicating with the event system 106. The partners may also generate system links 116 for inclusion in their applications/websites and or other applications/websites.

The environment includes one or more data providers 134. The data providers 134 may represent computing systems that provide event data (“external event data”) to the event system 106. The data providers 134 may be parties other than the partners and the operators of the event system 106. In some implementations, the data providers 134 may be businesses that provide data management and analytics services (e.g., to the partners, the event system 106, and other parties). The data providers 134 may collect additional data (e.g., in addition to the event system 106) regarding how users are using the partners' applications and websites. In some cases, the partners may use the data providers 134 to store event data and/or provide analytics. Example data management providers may include mParticle Inc. of New York, N.Y., and Segment Inc. of San Francisco, Calif.

The external event data may include data associated with events that occur with respect to the partners' websites and/or applications. Additionally, or alternatively, the external event data may be data associated with events that occur on websites and applications that are not operated by the partners. In some cases, the external event data may include event data that is otherwise not acquired by the event system 106 (e.g., via the app/web modules 114, 124). For example, the data providers 134 may receive additional event data via modules incorporated into the partners' websites/applications by other parties (e.g., the data providers themselves). The event system 106 may process external event data received from the data providers in a manner similar to event data received from the user devices 106.

FIG. 2 illustrates an example method that describes operation of the environment of FIG. 1. In block 200, the event system 106 provides app/web module components to partners for inclusion in partner applications 112 and websites 122. In block 202, the event system 106 receives event data from a plurality of user devices 100. Additionally, or alternatively, the event system 106 may receive event data from other sources, such as the partner systems 102 and/or the data providers 134. In block 204, the event system 106 generates user data objects based on the received event data. The user data objects may include event data for a single user device. In some implementations, a user data object may include event data for a plurality of user devices operated by the same user. In block 206, the event system 106 generates aggregate event data based on the user data objects.

In block 208, the search system 104 generates and updates entity records based on acquired entity data, such as data acquired from websites 122, 126, applications 112, 118, partner systems 102, and/or data providers 134. In block 210, the search system 104 generates popularity scores based on aggregate event data. The search system 104 may include the popularity scores in the entity records.

In block 212, the search system 104 receives a search request from a user device. The search request may include a search query along with additional data (e.g., a geolocation of the user device). In block 214, the search system 104 generates search results that include links to application states. The search system 104 may generate the search results based on aggregate event values, user event data for the user device, and/or popularity scores associated with the search results. The search results may include application/web links that access application states and/or websites. The search results may also include display data that the user device can use to render search results.

In block 216, the search system 106 sends the search results to the user device that generated the search request. In block 218, the user device (e.g., the search application) may render the search results as user-selectable links. In some implementations, the search results can be grouped by application. In other implementations, the search results can be grouped by vertical. The user can select (e.g., touch/click) an application link that causes the user device to access the application state associated with the link. Although the search system 104 can provide application links, in some implementations, the search system 104 can provide website links. In these implementations, the user can select a website link that causes the user device (e.g., web browser) to access the website associated with the website link.

FIG. 3A illustrates an example event system 106. The event system 106 includes an event data acquisition and processing module 300 (hereinafter “event processing module 300”) that acquires event data from a plurality of sources. Example event data may include app event data, web event data, and system link data. The event processing module 300 can generate user data objects 302 (e.g., see the example user data object 302 of FIG. 3B) based on the acquired event data. The event processing module 300 can also generate aggregate event data 304 based on the received event data and user data objects. The aggregate event data may indicate how a plurality of users are engaging with partner applications 112 and websites 122. The event processing module 300 can update the user data objects 302 and aggregate event data 304 over time (e.g., in response to newly received event data). The event system 106 includes an event data store 306 that can store received event data, including user data objects 302 and aggregate event data 304.

The event data received by the event system 106 may include device identifiers (“device IDs”) 308 that identify the user device that generated the event data. The event system can use the various device IDs for tracking events (e.g., application installations, application opens, and link selections) and attributing events to prior events. Some device IDs may be associated with a web browser on a user device (e.g., set by a web browser). Device IDs associated with the web browser may be referred to herein as “web IDs.” Example web IDs may include browser cookie IDs, which may be referred to as web cookies, internet cookies, or Hypertext Transfer Protocol (HTTP) cookies. Some device IDs may be associated with applications installed on the user device other than the web browser. In some cases, the device IDs may be operating system generated IDs that installed applications may access. Additional example device IDs may include advertising IDs, which may vary depending on the operating system (OS) on the user device.

The event system can store event data for individual users (e.g., in user data objects 302). Each user data object 302 may include data 310 (e.g., a list of events) indicating how a person uses one or more user devices over time. For example, a single user data object may include data indicating how a person uses a web browser and multiple applications on a single user device (e.g., a smartphone). In a more specific example, a single user data object may include data indicating how a person interacts with a partner's website and application. The event system 106 may store one or more user data objects 302 for each user device from which event data is received. The event system 106 may update existing user data objects in response to receiving event data associated with device IDs that are the same as device IDs included in existing user data objects. The event system 106 may generate a new user data object for each event associated with a new device ID. Since a single user device may generate multiple device IDs (e.g., web IDs and/or advertising IDs), the event system 106 may store multiple user data objects for a single device. The event system 106 can include matching functionality that identifies different user data objects that belong to the same user device. For example, the event system 106 may match two user data objects based on data including, but not limited to, the Internet Protocol (IP) addresses of the user devices, OS names, OS versions, device types, screen resolutions, and user identification data (e.g., a username). In some examples, the event system 106 may combine matching user data objects (e.g., combine event data).

In some cases, the event system 106 (e.g., the event response module 312) can leverage user data objects to provide responses to a user device based on past events generated by the user device, as illustrated by the following example. If a user selects a link for accessing content in an application that the user device does not have installed, the event system 106 (e.g., event response module 312) can log the selection of the link and can redirect the user to download/install the application. Upon opening the newly installed application, the application can transmit an event to the event system 106. The event system 106 (e.g., event response module 312) may match the two user data objects and, based on the match, the event system 106 can direct the opened application to the content linked to by the previously selected link. In this example, the opening of the application and installation of the application may be attributed to the selection of the link.

In some implementations, the event system 106 can generate and store data for use in user-selectable links, such as advertisement links and/or links to shared content. For example, the event system 106 may generate and store a system link data object that includes a system Uniform Resource Identifier (hereinafter “system URI”) and data. System link data objects can be stored in the system link data store 314. The system URI may indicate the network location of a system link data object (e.g., using a domain/path). The system URI may be included in a user-selectable link (referred to herein as a “system link”) in an application or on a website. Example user-selectable links may include hyperlinks, GUI buttons, graphical banners, or graphical overlays. In response to selection of a system link, a user device may access the event system 106 (e.g., the event response module 312), which may provide a response to the user device. For example, in response to receiving a system URI from a user device, the event response module 314 can retrieve data corresponding to the received system URI and perform a variety of functions based on the retrieved data. In one example, the event response module 314 can redirect the user device based on the data (e.g., to download the application or to a default location). In another example, the event response module 314 may pass the data (e.g., a discount code, user referral name, etc.) to the user device so that the user device can act based on the data. The event system 106 may log the selection of the system links and attempt to match the system link selections to other events included in the same user data objects or different user data objects.

The event system 106 can handle events and respond to the user devices. In one example, if the event system 106 has attributed an incoming event to a prior event, the event system 106 may handle the incoming event in a manner that depends on the prior event. In an example where the installation of an application is attributed to the prior user selection of a system link, the event system 106 may route the newly installed application according to the system URI of the prior selected system link. In some cases, if the event system 106 receives a system URI (e.g., event data indicating a click on a system link), the event system 106 can retrieve data associated with the system link. The event system 106 can then respond to the user device according to the data. For example, the event system 106 may route the user device (e.g., redirect the web browser) according to the data. The response provided by the event system 106 to the user device can vary, depending on a variety of factors. In some cases, the event system 106 may route the user device (e.g., web browser and/or application) in response to a received event. In some cases, the event system 106 may transfer data to the user device in response to a received event.

In some implementations, the event data may include user identification data 316 that identifies a user (e.g., a user ID). User identification data may include a username/login. In some cases, the username may include an email address. The user identification data may identify a user with respect to a website/application. In one specific example, the username and app ID pair may identify a user uniquely with respect to the application/website associated with an app name/ID. In some implementations, the user ID may be replaced by another identifier (e.g., a developer provided identifier). For example, the user ID may be replaced by an ID assigned by the developer that is a hash of a user ID or an internal app-provider database ID.

In some implementations, event data may include source data that indicates the source of an event. As described herein, event data may be generated in response to a user action, such as a user interacting with a link, webpage, or application state. For example, event data may be generated when a user views a webpage or application state, or when a user interacts with system links or other GUI elements included on a webpage or application state. The source data (e.g., on a per-event basis) may describe the network location and/or circumstances associated with the generation of the event data (e.g., the location where a link was viewed or selected).

The event data generated by the user device may be characterized as application event data (“app event data”) or web event data. The characterization of events may depend on whether the event data is generated via user interactions with the web browser or other applications. Web events may generally originate from the web browser 130 and may be associated with a web ID (e.g., a cookie ID). For example, web events may refer to events generated by the web module 124 of the partner's website 122. App events may generally originate from an application other than the web browser and may be associated with a device ID (e.g., a device ID other than a web ID, such as an advertising ID). For example, app events may refer to events generated by the app module 114 of the partner's application 112. Another type of event described herein is a link selection event that generates link data. The link selection event may be generated by the selection of a system link on a partner's website/application or in another website/application. A link selection event may be characterized as either an app event or web event, depending on how the user device handles the link selection. The event data may be received as HTTP requests or HTTP secure (HTTPS) requests in some cases. The event system 106 may handle link events (e.g., by sending a response) based on a variety of factors described herein, such as how the user device is configured to handle selection of a system link.

Web events may be associated with different types of device IDs than app events. For example, web event data may include a web ID (e.g., a cookie ID), while app event data may include a different type of device ID (e.g., an advertising ID).

The user device may transmit app event data (e.g., according to the app module 114) in response to a variety of different user actions. For example, the user device may transmit app event data in response to: 1) an application being opened (referred to as an “app open event”), 2) the user closing the application (referred to as an “app close event”), 3) the user adding an item to a shopping cart or the user purchasing an item (referred to generally as “application commerce events”), 4) the user opening the application after installation (referred to as an “app installation event”), 5) the user opening the application after reinstallation (referred to as an “app reinstallation event”), 6) the user requesting that a system URI be created by the event system 106 and transmitted back to the user device (e.g., in order to share content), 7) a user accessing a state of the application (e.g., an app page), 8) a user performing an action that the app module 112 has been configured by the operator of the event system 106 to report, and 9) the user performing any other action that the app module 112 has been configured by the partner to report to the event system 106 (i.e., a custom event defined by the partner). For example, a partner may define custom events to indicate that a specific application state (e.g., application page) or specific piece of content is viewed or shared.

The app event data received by the event system 106 may include, but is not limited to: 1) a device ID (e.g., an advertising ID, hardware ID, etc.), 2) an application name/ID that indicates the application with which the app event data is associated, 3) user identification data that identifies a user of the app (e.g., a username), 4) source data indicating the source of the event data, and 5) device metadata (e.g., user agent data), such as an IP address, OS identification data (e.g., OS name, OS version), device type, and screen resolution. The app event data may also include an event identifier that indicates the type of event. For example, the event identifier may indicate whether the app event is an app open event, an app close event, an app installation event, an app reinstallation event, a commerce event, or a custom event that may be defined by the developer in the app module. In the case the app event is an app open event that resulted from user-selection of a link (e.g., a system link), additional app event data may be transmitted by the user device, such as the URI (e.g., a system URI) that caused the user device to open the application. In some cases, the app event data may also include a web ID (e.g., appended to the system URI) associated with the URI. In some cases, the app event data may also include app-specific metadata, such as entity information (e.g., a business ID number in the application).

The event system 106 may perform a variety of different operations in response to receiving event data. For example, the event system may: 1) timestamp the received app event data (or use a received timestamp), 2) determine the source of the app event, 3) log the event data (e.g., update a database of user engagement), 4) determine if the app event can be attributed to any previous event, and/or 5) determine whether an app open event is an install event or a reinstall event. In the case the event system 106 receives a system URI, the event system may acquire data associated with the system URI. In the case the event system 106 receives a link generation request, the event system 106 can generate a link data object and transmit the system URI back to the user device.

The user device may transmit web event data (e.g., according to the web module 124) in response to a variety of different user actions. For example, the user device may transmit web event data in response to a user accessing a webpage (referred to as a “webpage view event”). Accessing a webpage may be the start of a web session (e.g., the first webpage access on the site) or a subsequent page view. The user device may also transmit web event data in response to the user adding an item to a shopping cart or the user purchasing an item (referred to generally as “web commerce events”), the user requesting that a system URI be created by the event system and transmitted back to the user device (e.g., in order to share content), a user performing an action that the web module 124 has been configured by the operator of the event system to report, and the user performing any other action that the web module 124 has been configured by the partner to report to the event system 106 (i.e., a custom web event defined by the partner). For example, a partner may define custom events to indicate that a specific webpage or specific piece of content is viewed or shared.

The web event data received by the event system may include, but is not limited to: 1) a web ID, 2) the website name/ID, which may correspond to the app name/ID or app ID in the event system 106, and 3) device/browser metadata (e.g., user agent data), such as IP address, OS identification data (e.g., OS name, OS version), device type, and screen resolution. The device/browser metadata may be extracted from the user agent sent by the web browser. The web event data may also include user identification data that identifies a user of the website (e.g., a username), source data indicating the source of the web event data, and an event identifier that indicates the type of event. For example, the event identifier may indicate whether the web event is a webpage view event, a commerce event, a link creation event, a sharing event, or a custom event defined by the developer in the web module 124. The web event data may also include the URI/URL for the current page and a referring URI/URL.

The event system 106 may perform a variety of different operations in response to receiving web event data. For example, the event system 106 may: 1) timestamp the received web event data (or use a received timestamp), 2) determine the source of the web event, 3) log the web event data, and/or 4) determine if the web event can be attributed to any previous event. In the case the event system 106 receives a link generation request, the event system 106 can generate a system link data object and transmit the system URI back to the user device. The event system 106 may also set a web ID on the user device in the case the web browser does not include a web ID.

User selection of a system link may be handled by the user device in a variety of ways, depending on how the user device is configured. In some cases, selection of a system link may cause an application to open, in which case the selection of the system link (e.g., the system URI) is passed to the event system 106 in the app open event. In other cases, the selection of a system link is handled by the web browser, which accesses the event system 106 using the system URI associated with the system link. In implementations where the web browser accesses the event system 106 in response to user selection of a system link, the link event data may include a web ID and device/browser metadata. The device/browser metadata (e.g., user agent data) may include an IP address, OS identification data (e.g., OS name, OS version), device type, and screen resolution.

The event system 106 may perform a variety of different operations in response to receiving link event data, including, but not limited to: 1) timestamping the received link event data (or using a received timestamp), 2) determining the source of the link event data, 3) logging the link event data, 4) retrieving data for the received system URI, 5) routing the user device to a location (e.g., a digital distribution platform for downloading the application, a default site, or other site) based on the retrieved data, and 6) setting a web ID in the case the web browser does not include a web ID.

The partner, or a user device (e.g., app/web module 114,124), can request system URIs from the event system 106. In the request, the partner (or the user device) can specify operations and data to be associated with a system URI. The system URI may include a domain name (e.g., example.com or www.example.com) and a path (e.g., example.com/path_segment1/path_segment2/). The domain name and path can be used to access the data object associated with the system URI via the network. In some cases, the scheme for the system URI may be a web uniform resource locator (URL) using http, or another scheme, such as ftp.

User data objects 302 may also include data that may be derived from the list of events for the app/website. Additional data may include, but is not limited to, a) a timestamp indicating the most recent usage of the app/website, b) a timestamp indicating the last time the app/website was accessed on a mobile device, c) a timestamp indicating the last time the app/website was accessed on a desktop device, d) activity data that indicates how often and when the app/website was used over a period of time (e.g., which days the app/website was used over a predetermined number of previous days), e) activity data that indicates how often the app/website was used on a mobile device, f) activity data that indicates how often the app/website was used on a desktop device, and g) a timestamp indicating the first time the user used the app/website (e.g., an earliest event in the list of events).

The event system 106 (e.g., the event processing module 300) can generate aggregate event data based on the app event data, web event data, and system link data. Aggregate app event data may include aggregate app usage data that indicates a number of users of the application over time. Example aggregate app usage data may include, but is not limited to, the number of daily active users (DAU) for the application and the number of monthly active users (MAU) for the application. The aggregate app usage data may also include the number of app events over time for a plurality of users. For example, aggregate app usage data may include the number of application opens over time, the number of different application states accessed over time, and the number of purchase events over time. In some implementations, the aggregate app event data may indicate a number of times systems links were generated for applications, used to access applications, and/or selected within an application state.

The aggregate app event data can be calculated for different geolocations, such as cities, states, and/or countries. For example, the aggregate app usage data may indicate the DAU for different countries. The aggregate app event data can also be calculated for different languages, different device types (e.g., smartphone type, laptop, desktop), different operating systems, different times of the day, and days of the week. The aggregate app event data can be calculated according to any combination of the parameters described herein. For example, the aggregate app event data may include a DAU count for a set of specific devices in a specific country.

Some aggregate event data may be associated with entities. Such aggregate event data may be referred to as “aggregate entity event data.” The aggregate entity event data can be stored in the respective entity records. Example aggregate entity event data may include a number of events for the entity over a time period, such as a daily event count or monthly event count. In some implementations, the aggregate events may be categorized according to the event type. For example, the aggregate data may indicate a number of times the application state was accessed over a period of time. As another example, the aggregate data may indicate a number of purchases associated with the entity over time. The aggregate entity event data can be calculated for different geolocations (e.g., cities, states, countries), languages, device types, operating systems, times of day, and days of week. Additionally, the aggregate entity event data can be calculated according to any combination of parameters. The aggregate entity event data can be used for scoring/filtering the entity records during search.

In some implementations, the event system 106 (e.g., the event processing module 300) may generate aggregate web event data that indicates a number of web events over a period of time, such as a number of times a domain/page was accessed. The aggregate web event data can be calculated for different geolocations, countries, languages, device types, operating systems, times of the day, and days of the week. The aggregate web event data can be calculated according to any combination of the parameters described herein. In some implementations, the aggregate web event data may indicate a number of times systems links were generated and/or accessed. In some implementations, the aggregate event data can be normalized.

FIG. 4 illustrates an example search system 104. The search system 104 includes a data acquisition module 400 and a data processing module 402 that acquire and process event data and entity data. The event data for individual users is stored as user data objects in the user-data data store 404. The entity data is included in entity records 406 stored in the entity data store 408. The entity records 406 may also include aggregate event data for the entities. The search system 104 may include a general data store 410 that stores acquired/processed data along with additional data used during search.

The data acquisition module 400 may acquire entity data from the data sources. Example data sources that may provide entity data include applications, websites, and other data providers. The data acquisition module 400 may include a crawling/scraping module that acquires entity data from websites (e.g., sitemaps and/or website contents), native applications, and/or API crawling. The search system 104 may also receive structured entity data from one or more data providers.

The search system 104 includes a query processing module 412 that receives the search requests including search queries. The search queries may include one or more words, numbers, and/or punctuation. The query processing module 412 can process the received search queries. For example, the query processing module 412 may parse the search query (e.g., using chart parsing), perform grammar matches on the search query, and add additional data to the search query for later use in search. Example additional data that may be added to the query terms may include, but are not limited to, term types (e.g., a term category), additional details regarding the string (e.g., geocoordinates and population for a place name), and additional strings (e.g., different spellings, synonyms, syntaxes, punctuations, and plural/singular versions) associated with the query terms. In some implementations, the query processing module 412 may process the search query based on data included in the string/type data store 414. For example, the string/type data store 414 may include associations between strings and term types or other data. The output of the query processing module 412 may include sets of search query terms that are each mapped to one or more term types or other additional data.

The search system 104 includes a search module 416 that identifies entity records based on the processed search request. For example, the search module 416 may identify entity records based on matches between terms of the search query (e.g., the processed search query) and terms of the entity records, such as the entity name and/or terms that are descriptive of the entity. The identified entity records may form a set of preliminary results.

The search module 416 may score the identified entity records in the preliminary results. The scores associated with the preliminary results may be referred to as “preliminary scores.” In some examples, the search module 416 may generate preliminary scores based on how well the terms of the search query match the terms of the entity record. The search module 416 may also perform additional scoring of the preliminary results. For example, the search module 416 may implement additional scoring functions and/or machine learned models that further score the preliminary results.

A result generation module 418 receives the scored/filtered preliminary results. In some implementations, the result generation module 418 may personalize the preliminary results. For example, the result generation module 418 may re-score/filter the preliminary results based on data included in the user data object for the user, such as the installation status of the applications for the user and/or the app usage frequency for the user.

The result generation module 418 may then generate search results including application links, display data, and result scores (e.g., the rescored preliminary results). The search results may be ranked and grouped according to the result scores. In some implementations, a link data store 420 may include the display data and application links indexed by entity ID. In some implementations, the result generation module 418 may generate the application links based on application link templates in the link data store. For example, the result generation module 418 may generate an application link by inserting at least one of an entity ID, an application ID, and an action ID into an application link template.

The preliminary scores and result scores described herein may refer to numerical values associated with various results (e.g., preliminary results and search results) that are generated during search. In general, the scores for the preliminary results and search results may indicate the relevance of the result to the search request, as determined by the search system 104. In some implementations, the scores may be decimal values from 0.00 to 1.00, where a score closer to 1.00 may indicate that the result is more relevant.

The data structures (e.g., entity records and user data objects) and data stores described herein are only example data structures and data stores. As such, a search system may implement the techniques of the present disclosure using additional/alternative data structures and data stores.

The search system 104 (e.g., data acquisition and processing modules 400, 402) may generate app-specific entity records and merged entity records. The entity data store 408 may store a plurality of app-specific entity records and/or merged entity records. FIG. 5A illustrates an example app-specific entity record 500. FIG. 5B illustrates an example merged entity record 502. The app-specific entity record 500 includes data related to an entity in a specific application, along with an application link (e.g., URL) to the entity within the specific application. For example, an app-specific entity record for a song entity in a music streaming application may include data associated with the song (e.g., artist, length, release date, genre), along with an application link that streams the song in the music streaming application. The entity records 500, 502 of FIGS. 5A-5B are only example entity records that include example data fields. Other entity records may include additional/alternative data fields. The data illustrated in the entity records 500, 502 may be stored as any suitable data structure in one or more data stores described herein.

The app-specific entity record 500 may include an app-specific entity name and/or identifier (ID) 504 that identifies an entity (e.g., uniquely identifies the entity). For example, an entity record can include an official name, along with a plurality of possible alternative names (e.g., name variations and/or alternative spellings). The variations in entity names within the entity record 500 may allow for a more robust match between terms of the search query and the entity records during a search.

The app-specific entity record 500 may include a vertical 506 (e.g., a category) associated with the entity. Example verticals may include, but are not limited to, points of interest (e.g., restaurants, businesses, attractions, museums), music (e.g., music videos, songs, and artist pages), business types (e.g., hotels), social (e.g., social media content), and news. In some examples, verticals can have sub-verticals (i.e., sub-categories). In some cases, the search system operator may define the verticals applied to the entities. Each application can be associated with one or more verticals. For example, the YELP® application may have verticals for hotels and restaurants. In this example, each of the entities can be associated with a vertical (e.g., one vertical per entity). For example, a hotel in the YELP® application (e.g., the link to the hotel) may be associated with a hotel vertical. Similarly, a restaurant in the YELP® application (e.g., the link to the restaurant) may be associated with the restaurant vertical.

Although an app-specific entity record described herein can include a single vertical, in some implementations, the app-specific entity record may include a plurality of verticals and/or one or more sub-verticals (e.g., sub-categories). In some implementations, the search system 104 can group/rank search results by vertical (e.g., see FIG. 8C).

The app-specific entity record 500 may include entity information 508, such as a postal address for the entity and/or the geolocation of the entity (e.g. latitude/longitude). The app-specific entity record may also include additional entity description, such as alternate names for the entity and data acquired from the application state and/or webpage for the entity. Example data from the application state and/or webpage may include, but is not limited to, a brief description of the entity, user reviews, rating numbers, and business hours. In some implementations, the entity information may have been acquired from the application states and/or on webpages associated with the entity.

Different entity records may have different entity information fields (e.g., vertical dependent data fields). For example, a movie entity in a streaming application may include a movie name, actor names, a movie genre, and a release date. As another example, a restaurant entity in a restaurant review application may include cuisine names, restaurant reviews, and ratings.

The app-specific entity record 500 may include aggregate entity event data 510 described herein. For example, the app-specific entity record 500 may indicate a number of events for the entity over a time period (e.g., daily/monthly). The entity record may also categorize the events according to event type. The aggregate event data 510 may include aggregate values for different geolocations (e.g., cities, states, countries), languages, device types, operating systems, times of day, days of week, and other combinations of parameters.

The app-specific entity record 500 may include one or more links (e.g., URLs) for accessing the entity. For example, the app-specific entity record 500 may include an application link 512 for accessing the entity in the application. Additionally, in some implementations, the app-specific entity record 500 may include a web link (e.g., web URL) and/or download link for downloading the application in the case the application is not installed on the user device. The application link, and other links, can be included in the search results.

The app-specific entity record 500 may include display data 514. The display data 514 may include text and/or images for rendering a search result on the user device. The search system 104 (e.g., result generation module 418) may include the display data in the search results. The application link and display data may be used to generate user-selectable search result links. As such, the application link and display data may be referred to as link generation data 516. Although the link generation data 516 is illustrated as included in the app-specific entity record 500, the link generation data 516 may be stored in other data stores illustrated herein, such as the link data store 420 of FIG. 4.

The app-specific entity record 500 may include a popularity score 518 for the app-specific entity. The search system (e.g., data processing module 402) may calculate the popularity score for the app-specific entity (e.g., see FIGS. 6A-6B), as described herein. In some implementations, the app-specific entity record may include a plurality of popularity scores for the entity (e.g., popularity scores for different countries, languages, etc.).

As described herein, the data acquisition module 400 may acquire entity data for generating the app-specific entity records. Additionally, the data processing module 402 may process the entity data and generate the entity records. In some implementations, entity data and event data included in a single app-specific entity record may be acquired from a plurality of different URLs. For example, a single application state (e.g., a restaurant page in a review application) may be accessed using a plurality of URLs. In cases where multiple URLs lead to a single app-specific entity, the data acquisition module 400 and data processing module 402 may normalize the entity data and event data to generate the single app-specific entity record. Normalization may include generating the entity name/ID and mapping the entity data and event data to the app-specific entity record.

FIG. 5B illustrates an example merged entity record 502. A merged entity record 502 may include a plurality of applications links 520 to the same entity in different applications. Each of the application links 520 can access an application state associated with the entity for a different application. For example, multiple applications can include pages for the same specific restaurant entity. In a specific example, the YELP® application and the TRIPADVISOR® application (developed by TripAdvisor, Inc.) may each have a review page for The French Laundry restaurant in Yountville, Calif. As another example, multiple applications can include pages for the same streaming movie.

The merged entity record 502 may also include display data 522 for each of the application links 520. The application links and display data may be referred to as link generation data 524. Although the link generation data 524 is illustrated as included in the merged entity record 502, the link generation data 524 may be stored in other data stores illustrated herein, such as the link data store 420 of FIG. 4.

The search system 104 (e.g., the data processing module 402) may generate the merged entity records using acquired entity data, including app-specific entity records. The data processing module 402 may merge app-specific entity data into a merged entity record based on similar data fields and data. For example, the data processing module 402 may merge app-specific entity records based on similar geolocations/addresses of the app-specific entities, similar names of the app-specific entities, and other similar data. In order to match data for merging, some data may be required to match exactly, while other data may be allowed to fuzzy match. In some implementations, a specific number of fields may also be required to match (e.g., exact and/or fuzzy). The merging may be implemented as a distributed process (e.g., MapReduce) for efficient scaling.

The merged entity record 502 may include a merged entity name/ID 526 that identifies the merged entity record 502. The merged entity record 502 may also include a vertical 527. The merged entity record 502 may also include app-specific IDs/names 528 used to generate the merged entity record 502. In some implementations, the entity data store 408 may include merged entity records 502 and app-specific entity records 500. In these implementations, the app-specific IDs/names 528 may point to app-specific entity records used to generate the merged entity records. In some implementations, the entity data store 408 may include merged entity records that directly represent the values of properties from app-specific entity records. In some implementations, the entity data store 408 may include merged entity records that include symbolic links and/or references to other app-specific entity records that include the relevant values.

The data processing module 402 may include data for multiple different app-specific entities in a single merged entity record. A merged entity record 502 may include more entity information 530 than an app-specific entity record because app-specific entity data for the same entity may vary by application. For example, a merged entity record may include additional entity data, such as additional entity names (e.g., alternative names), additional entity description, and additional data fields, such as a postal address, a phone number, a different rating, and different reviews. The additional data included in the merged entity record may provide a more complete understanding of the entity. The merged data (e.g., additional keywords) may also provide an enhanced ability to retrieve the entities during search. In some implementations, a merged entity record may include data that represents multiple possible values for a property collected from different applications (e.g., multiple possible entity names). In some implementations, a merged entity record may include only the single best value for a specific property, selected from one of multiple app-specific entity records.

In a specific example, a first app-specific entity record may be for the San Francisco Museum of Modern Art and a second app-specific entity record may be for SOMA (an acronym for the museum). In this specific example, the merged entity record may include both SOMA and San Francisco Museum of Modern Art as names. In another example, app-specific entity records may include different app-specific data. For example, a movie review application may include reviews for a specific movie and a streaming application may include a view count for the specific movie.

The merged entity records may also be associated with additional event data 532. For example, the event data 532 may include a combination of the event data associated with the application links 520 (e.g., the app-specific entity records). The additional event data may provide for enhanced calculations of popularity scores 534 that provide a more complete view of entity popularity across applications.

The merged entity records may include additional entity information, additional event data (e.g., aggregate event data), additional app-specific data, and popularity scores that can be used during search. In some implementations, the merged entity records may retain data from the app-specific records that may also be used during search. Identification of a merged entity record during search may surface one or more application links that can be scored in a similar manner as the links from the app-specific entity records.

In some implementations, the entity records 500, 502 may also include one or more actions (e.g., action IDs) associated with the entity. Example actions may include, but are not limited to, delivery, driving directions, information, reservations, and booking. The actions listed in the entity records may be matched to terms of the search query. In some implementations, the search module 416 may score/filter results based on matches between the entity records and the actions.

In some implementations, the entity records 500, 502 may also include one or more application names/IDs associated with the entity. The application name(s)/ID(s) listed in the entity record may be matched to terms of the search query. In some implementations, the search module 416 may score/filter results based on matches between the entity records and the app names. In some implementations, the result generation module 418 may generate application links based on the application name/ID and/or the action.

The entity records 500, 502 may also include fields indicating the sources of data (e.g., URLs) used to generate the entity records 500, 502. In some examples, entity data for an entity record may be acquired from a single application state or webpage. In other examples, entity data for an entity record may be acquired from multiple application states or webpages.

The search system 104 (e.g., the data processing module 402) can generate a popularity score for each entity record. The popularity score for an entity record may indicate the popularity of the entity. For an app-specific entity record, the popularity score may indicate popularity for the entity in the application. In a merged entity record, the popularity score can indicate the popularity of the entity across multiple applications. The search system 104 may use the one or more popularity scores as scoring/filtering features for the entity records during search.

The search system 104 may generate the popularity score for an entity based on the amount of engagement with the entity. For example, the search system 104 may determine the popularity score based on the engagement with the entity relative to the engagement with the other entities. A popularity score for an app-specific entity record may be referred to herein as an “app-specific popularity score.” A popularity score for a merged entity record may be referred to herein as a “merged popularity score” or a “global popularity score.”

The search system 104 may determine the popularity scores using aggregate event data, such as aggregate event data indicating the number of times the entity (e.g., application link) was accessed. For example, the search system 104 may determine the popularity score for the entity record based on the number of events associated with the application link. In some implementations, the popularity score may be a decimal value from 0.00-1.00. Higher popularity scores (e.g., closer to 1.00) may indicate that an entity is more popular than an entity with a lower popularity score (e.g., closer to 0.00). In general, entities that are accessed a greater number of times may have a higher popularity score (e.g., closer to 1.00). The popularity scores may be calculated in a variety of ways for the app-specific entities and the merged entities.

For an app-specific entity record, the search system 104 can generate an app-specific popularity score based on the number of events associated with the entity and the number of events associated with other entities. For example, the search system 104 can divide the number of events associated with the app-specific entity by the number of events associated with the entity having the most events (e.g., a maximum count value). In this example, the entity associated with the most events will have a popularity score of 1.00. Furthermore, in this example, entities associated with fewer events will have a popularity score that is closer to 0.00.

In some implementations, the search system 104 can generate a popularity score for an app-specific entity record using a log function for the numerator and denominator. For example, the app-specific popularity score may be calculated as log(events+1)/log(max_events+1). The function may be raised to a power in some implementations. The log function calculation may better represent the popularity of the entities when the amount of engagement is not proportional to the popularity of the entity (e.g., half the engagement does not mean half the popularity). In some implementations, the search system 104 may use an “artificial maximum” count value (e.g., set by a function and/or the search system operator). For example, an artificial maximum may be used when one or more maximum event counts are outliers and/or associated with an application that is not being considered in calculation of the popularity score.

In some implementations, the search system 104 may treat different types of events for an entity differently in the popularity score calculation. For example, the system may calculate the popularity score using a function that applies different weights to different types of engagements. In a specific example, an entity may have 100 open events and 200 pageview events. In this example, the total count of engagements used to calculate popularity may be opens multiplied by two plus pageviews (e.g., 2*100+200=400). When using a weighting function for popularity score, the popularity score may be calculated by dividing the weighted function value for the entity by the largest weighted function value for an entity. In some implementations, the search system 104 may generate a machine learned model for calculating popularity scores based on multiple types of events.

In some implementations, the search system 104 can determine a popularity score using data other than event data. For example, the search system 104 may determine a popularity score using other data when a sufficient amount of event data is not available for an entity. The other data may indicate an amount of engagement with an entity in an application, such as a number (e.g., count) of individual engagements with the entity in the installed application. The search system 104 may acquire the other data from data providers 134, partners, and/or application/website crawling, for example. In some implementations, the other data may be data that is specific to the application. In this case, the other data may be referred to as app-specific count data. Examples of app-specific count data may include, but are not limited to, a number of reviews for a book entity in an application, a number of views for a movie in a streaming video application, a number of listens for a song in a music playing application, and a number of users that used a recipe in a cooking application.

After acquiring one or more types of other data, the search system 104 may determine the popularity score in a similar manner as described above with respect to the scoring function, log scoring function, and/or weighting function. For example, after determining a number of views for a movie, the search system 104 may calculate the popularity of the movie by dividing the number of views for the movie by the largest number of views for any movie. In some implementations, the search system 104 may choose an artificial maximum number for other data when a maximum number is not determined.

In some implementations, the search system 104 may determine the popularity score based on one or more types of event data and/or one or more types of other data (e.g., app-specific count data). In these implementations, the search system 104 may use a weighting function and/or a machine learned model to determine the popularity score. For example, the machine learned model may receive multiple features, such as values for event types and other data counts, and output a popularity score. The machine learned model may be generated using a target function (e.g., a function created by assigning scores to training data).

The search system 104 may calculate popularity scores using data for a specific window of time, such as over a day, week, or month. With respect to event data, the search system 104 can select event data based on the times the events occurred (e.g., based on timestamps). The search system 104 can identify values to use for other data counts in a variety of ways, depending on how the other data is collected. In some implementations, the other data counts (e.g., video views) may represent a running total over all time. In these implementations, the search system 104 may acquire values of the other data over time (e.g., daily) and use subtraction to determine proper values over a specified window of time. In some cases, the other data may be directly used if provided over the proper time window, such as a total number of daily/monthly video views.

In some implementations, an app-specific entity record may include a single popularity score. In some implementations, an app-specific entity record may include different types of popularity scores. For example, the app-specific entity record may include popularity scores for different geolocations/countries, languages, and device types. In some implementations, the search system 104 can generate app-specific popularity scores by entity vertical. The different popularity scores may be calculated as described herein using different sets of data (e.g., event data by country, language, device type, etc.).

The merged entity record 502 can include one or more popularity scores 534. For example, the merged entity record 502 may include popularity scores for app-specific entity records. The merged entity record 502 may also include a global popularity score.

The search system 104 can generate a global popularity score in a variety of ways. In some implementations, the search system 104 can generate a global popularity score based on a combination of the app-specific popularity scores. For example, the search system 104 may calculate the global popularity score by averaging the app-specific popularity scores. As another example, the search system 104 can use a function that weights the different app-specific popularity scores based on the application associated with the popularity scores. In a specific example, more popular applications may have greater weight associated with their popularity scores. In some implementations, the global popularity score may be calculated from a weighted average of the application specific popularity scores. In some implementations, the search system 104 can generate the global popularity score by setting the maximum app-specific popularity score as the global popularity score. In other implementations, the search system 104 may assign the popularity score of the most trusted application as the global popularity score.

In some implementations, the search system 104 may calculate a global popularity score based on the events associated with individual applications. For example, the search system 104 can use a function that weights the different app-specific events based on the application associated with the events (e.g., based on the application popularity). In this example, the search system 104 may give a heavier weighting to events from more popular applications. The search system 104 may determine these popularity scores in a similar manner as described herein with respect to the scoring function, log scoring function, weighting function, and machine learned model.

In some implementations, the search system 104 may determine the global popularity scores using a machine learned model. For example, the machine learned model may receive multiple features, such as values for event types, app-specific popularity values, and other data, and then output a popularity score. The machine learned model may be generated using a target function (e.g., a function created by assigning scores to training data). A machine learned model may also handle cases where features are missing, such as missing entities/applications and where merged entities have different covered applications. For example, one restaurant entity may have event data from a first application and a second application, while another entity may have data from the first application and a third application, but not the second application.

In some implementations, a merged entity record may include a single global popularity score. In some implementations, a merged entity record may include different types of global popularity scores. For example, the merged entity record may include popularity scores for different geolocations/countries, languages, and device types. In some implementations, the search system 104 can generate global popularity scores by entity vertical. The different popularity scores may be calculated as described herein using different sets of data (e.g., event data by country, language, device type, etc.).

FIGS. 6A-6B illustrate example methods for calculating popularity scores. FIG. 6A illustrates an example method for calculating popularity scores based on aggregate event data. In block 600, the search system 104 determines event counts for entities (e.g., entity records) based on aggregate event data. In block 602, the search system 104 determines popularity scores for entities based on the event counts associated with the entity records. For example, the search system 104 may determine popularity scores for an entity record based on the number of events associated with the entity record relative to the number of events associated with other entity records. Additional/alternative calculations for app-specific and merged entity records are described herein. In block 604, the search system 104 stores the generated popularity scores in the respective entity records. In blocks 606-608, the search system 104 may receive search requests and generate search results based on the popularity scores associated with the entity records. For example, the search system 104 may use the popularity scores as scoring/filtering features during search.

FIG. 6B illustrates an example method for calculating popularity scores based on app-specific data. In block 610, the search system 104 generates app-specific count data for each entity, where the app-specific count data indicates a number of engagements with the entity in the respective application. The search system 104 may generate the app-specific count data based on data from data providers 134, partners, and/or application/website crawling. In block 612, the search system 104 determines popularity scores for entities based on the app-specific count data associated with the entity records. For example, the search system 104 may determine popularity scores for an entity record based on the number of app-specific counts associated with the entity record relative to the number of app-specific counts associated with other entity records. Additional/alternative calculations based on app-specific counts for app-specific and merged entity records are described herein. In block 614, the search system 104 stores the generated popularity scores in the respective entity records. In blocks 616-618, the search system 104 may receive search requests and generate search results based on the popularity scores associated with the entity records.

FIG. 7A illustrates an example search system 104 performing a search in response to receipt of a search request from a user device. FIG. 7B illustrates an example search method. The method of FIG. 7B is described with respect to the functional block diagram of FIG. 7A.

In block 700, the query processing module 412 receives the search request from the user device. The search request may include a search query, geolocation data, and other data. In block 702, the query processing module 412 processes the received search request.

In block 704, the search module 416 generates preliminary results based on the search request, popularity scores, and other features. The preliminary results may include a set of entity records and corresponding preliminary scores. The search module 416 identifies entity records in the entity data store 408 (e.g., entity search index) based on the processed search query. For example, the search module 416 may identify entity records based on matches between the search query terms and text included in the entity records. The search module 416 may also identify entity records based on matches between the user's current or query-specified geolocation and the geolocation of entities in the entity records. Identification of the entity records may include one or more database queries that may include keywords, app names, verticals, actions, user geolocation, and other parameters.

In some implementations, the search module 416 may implement additional scoring of the identified entity records. For example, the search module 416 may score the entity records based on features of the search query (e.g., query popularity), features of the entity records (e.g., entity popularity scores), and/or features based on intersections between the search query and the entity record. The additional scoring (e.g., secondary scoring) may use one or more scoring functions, one or more machine learned models, and/or business rules.

In some implementations, the additional scoring may be based on event data included in the entity record, such as the aggregate event data described herein. For example, the aggregate event data may be used as scoring features. In some implementations, the additional scoring may be based on the popularity scores associated with the entity records. For example, the popularity scores may be used as scoring features.

In block 706, the result generation module 418 can score/filter the preliminary results based on user data associated with the user device or user that sent the search request. The user data may be acquired from the user data object for the specific user (e.g., as indicated by a received device ID or user ID). Scoring the preliminary results based on user data may result in personalized search results that are more relevant to the user.

In some implementations, the result generation module 418 may score/filter preliminary results based on the installation status of applications associated with the preliminary results. For example, the result generation module 418 may filter out (e.g., remove) or penalize links to applications that are not installed. As another example, the result generation module 418 may boost preliminary results for applications that are installed. In some implementations, the result generation module 418 may score/filter preliminary results based on the user's application usage (e.g., one or more application usage values). For example, the result generation module 418 may score/filter based on the amount an application is used, such as the frequency of usage or total usage. In this example, preliminary results associated with higher application usage may be boosted. In some implementations, the result generation module 418 may score/filter results based on the recency of application usage. For example, results for more recently used applications may be scored higher. In this example, results associated with applications that have not been used in a period of time may be filtered out.

Additional personalization can be based on personalized usage patterns, such as the day of the week applications are used and/or the time of day the applications are used. In this example, the result generation module 418 may boost results that are associated with applications the user uses at the current time of day or day of week. Additional personalization can be based on application installation status and usage by device type (e.g., laptop, smartphone, etc.). For example, the result generation module 418 may score/filter results based on user historical application usage by device. Although personalization is attributed to the result generation module 418 herein, the personalization may also be performed by the search module 416, such as during an initial database query and/or during additional scoring (e.g., using a machine learned model).

In block 708, the result generation module 418 may generate search results based on the score/rank of the preliminary results. The search results may include a plurality of application links, display data for the links, and associated result scores. The result scores associated with the search results may be referred to as “search result scores” or “result scores.” In some implementations, the result generation module 418 may retrieve the application links form the entity records or link data store 420. In some implementations, the result generation module 418 may generate application links using a template. In some implementations, the result generation module 418 may generate a search application link by inserting the user's search query into an application search link template. In this case, the generated search application link may open a search results page in an application that has been generated according to the user's search query.

In block 710, the search system 104 sends the search results to the user device. In block 712, the user device displays the search results to the user. In some implementations, the user device (e.g., search application) can rank the search results.

FIG. 8A illustrates an example set of search results displayed on the user device (e.g., by the search application 132). In FIGS. 8A-8C, the search query is “Avengers,” which may be a query related to a popular movie franchise. FIG. 8A includes six search results 800-1, 800-2, . . . , 800-6 across three different applications. The result applications include 1) a StreamIt Application that provides streaming movies to a user, 2) an InTheater application that provides movie tickets for watching movies in a theater, 3) a FilmTicks application that provides movie tickets for watching movies in a theater, and 4) a Soundtrack application that provides streaming music.

The search results in FIGS. 8A-8C are for application states associated with the Avengers movie franchise. Result 800-1 is an application link to stream the Avengers (2012) movie in the StreamIt application. Result 800-2 is an application link to stream an Avengers—Behind the Scenes movie in the StreamIt application. Result 800-3 is an application link to purchase theater tickets for the Avengers (2019) movie in the InTheater application. Result 800-4 is an application link to purchase theater tickets for the Avengers (2019) movie in the FilmTicks App. Result 800-5 is an application link to listen to the Avengers (2012) soundtrack in the Soundtrack application. Result 800-6 is an application link to listen to the Avengers (2019) soundtrack in the Soundtrack application.

In FIG. 8A, it can be assumed that the search results are ranked by result score, where the largest result scores (e.g., closer to 1.00) are ranked higher in the search results. In some implementations, the search system 104 and/or the search application 132 may group the search results. For example, with respect to FIGS. 8B-8C, the search system 104 and/or the search application 132 may group the search results by application and/or vertical. Grouping results by application or vertical may provide a user experience that helps the user quickly understand the context of the application link they are selecting.

FIG. 8B illustrates the example search results of FIG. 8A grouped by application. The groups of results may be referred to as application groups. In implementations where the search system 104 groups search results by application, the search system 104 can rank the application groups. For example, the search system 104 (e.g., the result generation module 418) can score/filter the application groups and rank the application groups by score. A score associated with an application group may be referred to as an “application group score.”

In some implementations, the search system 104 can rank application groups based on the result scores associated with search results in the application groups. For example, the search system 104 can identify the highest scoring search result and set the application group associated with the highest scoring search result highest in the search result page. The search system 104 can then identify the next highest search result score and rank the application group for the result score next highest in the search result page. In another implementation, the search system 104 can rank application groups based on the average result score for the search results associated with the application. For example, the search system 104 can rank application groups associated with higher average result scores higher in the search results page.

In some implementations, the search system 104 can determine an application group score for an application group based on aggregate event data associated with the application group. In some implementations, the search system 104 may rank the application groups based on the usage rate of the application (e.g., DAU/MAU) according to aggregate event data. In some implementations, the usage rate of the application may be personalized to the user based on the user's country and/or the user device type.

In some implementations, the search system 104 can rank the application groups based on user data (e.g., data included in the user data object). Example user data may include the installation status of the applications on the user device (e.g., rank installed apps higher and/or filter out applications that are not installed), recency of the app usage (e.g., the last used apps ranked higher), the frequency of application usage (e.g., the most used apps ranked higher).

The search system 104 can use any of the application group ranking techniques described herein. For example, the search system 104 may rank the application groups based on a combination of the factors described herein. In one example, the search system 104 may rank application groups based on aggregate event data and user data. In another example, the search system 104 may rank the application groups according to a tiered approach. For example, the search system 104 may first determine whether the user device has the applications installed. If the applications are installed, the search system 104 may rank the application groups according to personal usage. If the applications are not installed, the search system 104 may rank the applications by aggregate event data.

FIG. 8C illustrates example groupings of search results by vertical. The three verticals represented in FIG. 8C include Movie Tickets, Streaming Movies, and Music. As illustrated, the Avengers (2019) tickets entity in the InTheater application and the Avengers (2019) tickets entity in the FilmTicks application are associated with the Movie Tickets vertical. Furthermore, the Avengers (2012) entity and the Avengers—Behind the Scenes entity are associated with the Streaming Movies vertical. Additionally, the Avengers (2012) and the Avengers (2019) soundtrack results are associated with the Music vertical. Note that the verticals associated with the entities may be stored in the entity records (e.g., see FIGS. 5A-5B).

The search system 104 can rank each vertical result group. For example, the search system 104 may rank the vertical result groups based on the user's vertical intent. A user's vertical intent may refer to one or more of the user's desired verticals for search results (e.g., as indicated by the search query). For example, if the search query is “Mexican restaurants,” the user may intend to view search results associated with the restaurant vertical. In some implementations, the search system 104 may also rank search results within the vertical result groups.

The search system 104 can identify a user's vertical intent in a variety of ways. For example, the search system 104 may identify a user's vertical intent based on the search query and/or the preliminary results. The search system 104 can generate a vertical intent data structure that indicates the user's vertical intent. In some implementations, the vertical intent data structure may include a ranked list of verticals. The ranked list of verticals may be ordered based on how well the vertical matches the user's vertical intent (e.g., the relevance of the vertical to the search query). In some implementations, each vertical can be associated with a vertical intent score that indicates how well the vertical matches the user's vertical intent. The score can be from 0.00-1.00, for example. In general, the search system 104 may rank the vertical groups associated with higher vertical intent scores higher in the search results.

In some implementations, the search system 104 may determine vertical intent based on the user's search query. For example, the search system 104 may identify the vertical intent of the user directly in the query. In a specific example, a query for “Avengers movie tickets” may indicate that the user's desired vertical is “Movie Tickets.” In some implementations, each vertical may be associated with a plurality of additional words that are associated with the vertical, such as vertical alternative names and synonyms. The words associated with the vertical may be included in one or more data stores. In this example, inclusion of the words associated with the vertical may indicate the user's vertical intent. For example, if the vertical “Movie Tickets” has associated words “Film Tickets,” a query including the terms “film tickets” may indicate a “Movie Ticket” vertical intent. A greater number of term matches may yield a higher vertical intent score.

In some implementations, the search system 104 may determine vertical intent based on the preliminary results. As described herein, each of the preliminary results may be associated with a vertical. In these implementations, the search system 104 may determine the vertical intent based on the verticals associated with the preliminary results. In some implementations, the search system 104 may rank the vertical result groups by the preliminary scores associated with the preliminary results. For example, verticals associated with higher preliminary scores may be ranked higher in the search results. In a specific example, the vertical having the highest scoring preliminary result may be set as the highest ranking vertical result group. In other implementations, the search system 104 may rank the vertical result groups based on the number of times a vertical appears in the preliminary results, where verticals that appear more may cause corresponding vertical groups to appear higher in the results. In one example, the most frequently occurring vertical in the highest N scoring preliminary results may be selected as the highest ranking vertical. In another example, the vertical associated with the highest average preliminary score may be selected as the highest ranking result.

In some implementations, features such as popularity may be used to determine vertical intent. For example, the vertical of the result with the highest popularity may be ranked as the highest vertical intent. In some implementations, the number of results in a vertical may be used to determine vertical intent. In other cases, a machine learned model may be used to consider query words as well as preliminary search results to predict vertical intent. In some implementations, user data may be a feature for vertical intent determination. For example, if the user regularly uses music applications, but does not have any movie ticket applications, then the music vertical may be more likely.

In addition to ranking the vertical groups, the search system 104 may rank the individual search results within the vertical groups. The search system 104 may rank the individual search results based on any of the scoring/filtering described herein, such as scoring/filtering based on application installation, aggregate event data, and user data.

In some implementations, when search results for the same application are associated with different verticals, the search system 104 may include results for the same application within the same vertical group, instead of splitting the search results into their respective verticals. For example, if the search results include two or more application links having different verticals for the same application, the search system 104 may group the two or more application links under the same vertical. In a specific example, the search system 104 may group the two or more application links under their highest ranking vertical and then order the application links based on result score.

In some implementations, the search application 132 and/or search webpage can include a GUI element (e.g., a button) that allows the user to select the type of grouping. The grouping selection (e.g., by vertical or by application) can be indicated in the search request. In some cases, the vertical intent scores can be sent to the user device for grouping at the user device.

In some implementations, the search system 104 and/or the search application 132 may group search results by action. In these implementations, the search system 104 and/or the search application 132 may group the search by action in a similar manner as grouping by vertical intent. In addition to ranking the action groups, the search system 104 may rank the individual search results within the action groups.

FIG. 9 illustrates an example search system 104 performing a search in response to receipt of a search request from a user device. FIG. 10 illustrates an example search method. The method of FIG. 10 is described with respect to the functional block diagram of FIG. 9.

In block 1000, the query processing module 412 receives the search request from the user device and processes the search request. The query processing module 412 may process the search request based on data included in the string/type data store 414. The query processing module may output the processed search query to the search module 416.

In block 1002, a database query module 902 performs a database query of the entity data store 408 to identify a set of entity records (e.g., preliminary results) based on the search request, popularity scores, and other features. In block 1004, a preliminary result processing module 904 may perform additional scoring/filtering of the preliminary results (e.g., using a scoring function, machine learned model, and/or business logic). In block 1006, a vertical intent calculation module 900 may determine the user's vertical intent (e.g., a vertical intent data structure) based on the user's search query and/or the preliminary results. In some implementations, instead of determining vertical intent at the search module 416, the query processing module 412 may determine the vertical intent (e.g., a vertical intent data structure) based on the search query and/or other data in the search request.

In block 1008, a link processing module 906 may score/filter the preliminary results based on user data associated with the user device (or user) that sent the search request. The user data may be acquired from the user data object in the user-data data store 404. In block 1010, the link generation module 908 may generate the search results based on the preliminary results and the vertical intent data structure(s). For example, the link generation module 908 may retrieve/generate the application links based on data in the link data store 420 and output the search results ranked by result score, vertical intent, and/or associated application. In block 1012, the search system 104 sends the search results to the user device for display.

Modules and data stores included in the systems 104, 106 represent features that may be included in the systems 104, 106 of the present disclosure. The modules and data stores described herein may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

The one or more processing units may include one or more central processing units (CPUs), graphics processing units (GPUs), digital signal processing units (DSPs), or other processing units. The one or more processing units may be configured to communicate with memory components and I/O components. For example, the one or more processing units may be configured to communicate with memory components and I/O components via the interconnect components.

A memory component (e.g., main memory and/or a storage device) may include any volatile or non-volatile media. For example, memory may include, but is not limited to, electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc, digital versatile disc, and/or Blu-ray Disc), or any other memory components.

Memory components may include (e.g., store) data described herein. For example, the memory components may include the data included in the data stores. Memory components may also include instructions that may be executed by one or more processing units. For example, memory may include computer-readable instructions that, when executed by one or more processing units, cause the one or more processing units to perform the various functions attributed to the modules and data stores described herein.

The I/O components may refer to electronic hardware and software that provides communication with a variety of different devices. For example, the I/O components may provide communication between other devices and the one or more processing units and memory components. In some examples, the I/O components may be configured to communicate with a computer network. For example, the I/O components may be configured to exchange data over a computer network using a variety of different physical connections, wireless connections, and protocols. The I/O components may include, but are not limited to, network interface components (e.g., a network interface controller), repeaters, network bridges, network switches, routers, and firewalls. In some examples, the I/O components may include hardware and software that is configured to communicate with various human interface devices, including, but not limited to, display screens, keyboards, pointer devices (e.g., a mouse), touchscreens, speakers, and microphones. In some examples, the I/O components may include hardware and software that is configured to communicate with additional devices, such as external memory (e.g., external HDDs).

In some implementations, the systems 104, 106 may include one or more computing devices that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the systems 104, 106 may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the systems 104, 106 may be configured to communicate with the network 108. The one or more computing devices of the systems 104, 106 may also be configured to communicate with one another (e.g., via a computer network). In some examples, the one or more computing devices of the systems 104, 106 may include one or more server computing devices configured to communicate with user devices. The one or more computing devices may reside within a single machine at a single geographic location in some examples. In other examples, the one or more computing devices may reside within multiple machines at a single geographic location. In still other examples, the one or more computing devices of the systems 104, 106 may be distributed across a number of geographic locations.

What is claimed is:

1. A method comprising:
storing, at a server, a plurality of entity records, wherein each entity record includes:
entity information that describes an entity; and
an application link configured to access an application state associated with the entity;
receiving, at the server, event data generated by a plurality of user devices, wherein the event data indicates a number of times each of the application states was accessed by the user devices;
determining, at the server, a popularity score for each entity record based on the received event data, wherein the popularity score indicates the number of times the application state for the entity record was accessed relative to the number of times one or more other application states were accessed;
receiving, at the server, a search request from a remote requesting device;
identifying, at the server, a set of preliminary result entity records based on matches between the search request and the entity information included in the preliminary result entity records;
generating, at the server, result scores for each of the preliminary result entity records based on the popularity scores associated with the preliminary result entity records;
generating, at the server, search results that include application links from the preliminary result entity records, wherein the application links in the search results are ranked according to the result scores associated with the application links; and
sending the search results from the server to the requesting device.

2. The method of claim 1, wherein the event data is generated by native applications installed on the user devices.

3. The method of claim 1, wherein the popularity score for each entity record is a ratio of the number of times the application state for the entity record was accessed relative to the number of times one or more other application states were accessed.

4. The method of claim 3, wherein the event data is categorized by event types, wherein each event type is associated with a weighting value, and wherein the ratio is a function that includes terms weighted by the event type weighting values.

5. The method of claim 1, wherein each entity record includes a plurality of application links configured to access application states associated with the entity in multiple applications, the method comprising determining the popularity score for each entity record based on the received event data, wherein the popularity score indicates the number of times the application states for the entity record were accessed relative to the number of times application states were accessed in other entity records.

6. The method of claim 1, wherein the method comprises:
acquiring application-specific data for the application states associated with the entity records, wherein the application-specific data indicates an amount of engagement with the application states;
determining application-specific count values for each entity record based on the application-specific data; and
determining the popularity score for each entity record based on the received event data and the application-specific count values.

7. The method of claim 1, wherein the plurality of entity records is a first plurality of entity records, and wherein the method further comprises:
storing a second plurality of entity records that each include:
entity information that describes an entity; and
an application link configured to access an application state associated with the entity;
acquiring application-specific data for the application states associated with the second plurality of entity records, wherein the application-specific data indicates an amount of engagement with the application states of the second plurality of entity records;
determining application-specific count values for each entity record of the second plurality of entity records based on the application-specific data; and
determining a popularity score for each entity record of the second plurality of entity records based on the application-specific count values, wherein the set of preliminary result entity records includes entity records from the first and second plurality of entity records.

8. The method of claim 1, wherein the requesting device is one of the user devices, and wherein the method further comprises determining an application usage value for each application used on the requesting device, wherein the application usage values indicate a frequency at which the applications are used on the requesting device, and wherein generating result scores comprises generating results scores for each of the preliminary result entity records based on the application usage values.

9. The method of claim 1, wherein the requesting device is one of the user devices, and wherein the method further comprises:
for each preliminary result entity record, determining whether the application associated with the application link is installed on the requesting device based on the received event data; and
removing entity records from the set of preliminary result entity records for which the associated application is not installed on the requesting device.

10. The method of claim 1, wherein the requesting device is one of the user devices, and wherein the method further comprises:
grouping the search results into a plurality of application groups, each application group being associated with a different application;
determining an application usage value for each application associated with an application group, wherein the application usage values indicate a frequency at which the applications are used on the requesting device; and
ranking the application groups based on the application usage values.

11. The method of claim 1, wherein each entity record includes a vertical data field that indicates a category of the entity, the method further comprising:
grouping the search results into a plurality of vertical groups based on the vertical associated with the search results, each vertical group being associated with a different vertical;
determining a vertical intent data structure based on the search request, wherein the vertical intent data structure includes a list of ranked verticals; and
ranking the vertical groups according to the vertical intent data structure.

12. A system comprising:
one or more storage devices configured to store a plurality of entity records, wherein each entity record includes:
entity information that describes an entity; and
an application link configured to access an application state associated with the entity; and
one or more processing units that execute computer-readable instructions that cause the one or more processing units to:
receive event data generated by a plurality of user devices, wherein the event data indicates a number of times each of the application states was accessed by the user devices;
determine a popularity score for each entity record based on the received event data, wherein the popularity score indicates the number of times the application state for the entity record was accessed relative to the number of times one or more other application states were accessed;
receive a search request from a remote requesting device;
identify a set of preliminary result entity records based on matches between the search request and the entity information included in the preliminary result entity records;
generate result scores for each of the preliminary result entity records based on the popularity scores associated with the preliminary result entity records;
generate search results that include application links from the preliminary result entity records, wherein the application links in the search results are ranked according to the result scores associated with the application links; and
send the search results to the requesting device.

13. The system of claim 12, wherein the event data is generated by native applications installed on the user devices.

14. The system of claim 12, wherein the popularity score for each entity record is a ratio of the number of times the application state for the entity record was accessed relative to the number of times one or more other application states were accessed.

15. The system of claim 14, wherein the event data is categorized by event types, wherein each event type is associated with a weighting value, and wherein the ratio is a function that includes terms weighted by the event type weighting values.

16. The system of claim 12, wherein each entity record includes a plurality of application links configured to access application states associated with the entity in multiple applications, wherein the one or more processing units are configured to determine the popularity score for each entity record based on the received event data, and wherein the popularity score indicates the number of times the application states for the entity record were accessed relative to the number of times application states were accessed in other entity records.

17. The system of claim 12, wherein the one or more processing units are configured to:
acquire application-specific data for the application states associated with the entity records, wherein the application-specific data indicates an amount of engagement with the application states;
determine application-specific count values for each entity record based on the application-specific data; and
determine the popularity score for each entity record based on the received event data and the application-specific count values.

18. The system of claim 12, wherein the plurality of entity records is a first plurality of entity records, wherein the one or more storage devices are configured to store a second plurality of entity records that each include:
entity information that describes an entity; and
an application link configured to access an application state associated with the entity, and wherein the one or more processing units are configured to:
acquire application-specific data for the application states associated with the second plurality of entity records, wherein the application-specific data indicates an amount of engagement with the application states of the second plurality of entity records;
determine application-specific count values for each entity record of the second plurality of entity records based on the application-specific data; and
determine a popularity score for each entity record of the second plurality of entity records based on the application-specific count values, wherein the set of preliminary result entity records includes entity records from the first and second plurality of entity records.

19. The system of claim 12, wherein the requesting device is one of the user devices, and wherein the one or more processing units are configured to determine an application usage value for each application used on the requesting device, wherein the application usage values indicate a frequency at which the applications are used on the requesting device, and wherein generating result scores comprises generating results scores for each of the preliminary result entity records based on the application usage values.

20. The system of claim 12, wherein the requesting device is one of the user devices, and wherein the one or more processing units are configured to:
for each preliminary result entity record, determine whether the application associated with the application link is installed on the requesting device based on the received event data; and
remove entity records from the set of preliminary result entity records for which the associated application is not installed on the requesting device.

21. The system of claim 12, wherein the requesting device is one of the user devices, and wherein the one or more processing units are configured to:
group the search results into a plurality of application groups, each application group being associated with a different application;
determine an application usage value for each application associated with an application group, wherein the application usage values indicate a frequency at which the applications are used on the requesting device; and
rank the application groups based on the application usage values.

22. The system of claim 12, wherein each entity record includes a vertical data field that indicates a category of the entity, and wherein the one or more processing units are configured to:
group the search results into a plurality of vertical groups based on the vertical associated with the search results, each vertical group being associated with a different vertical;
determine a vertical intent data structure based on the search request, wherein the vertical intent data structure includes a list of ranked verticals; and
rank the vertical groups according to the vertical intent data structure.
